(19) United States
(12) Patent Application Publication
(10) Pub. No.: US 2013/0323518 A1
(43) Pub. Date: Dec. 5, 2013

(54) COATING PROCESS, COATING, AND COATED COMPONENT

(71) Applicants: Surinder Singh PABLA, Greer, SC (US); Gilbert Otto KRAEMER, Greer, SC (US); Richard Todd EVERHART, Simpsonville, SC (US); William Francis CARNELL, JR., Greer, SC (US)

(72) Inventors: Surinder Singh PABLA, Greer, SC (US); Gilbert Otto KRAEMER, Greer, SC (US); Richard Todd EVERHART, Simpsonville, SC (US); William Francis CARNELL, JR., Greer, SC (US)

(73) Assignee: GENERAL ELECTRIC COMPANY, Schenectady, NY (US)

(21) Appl. No.: 13/488,794

(22) Filed: Jun. 5, 2012

(51) Int. Cl. B05D 1/36; B32B 9/00; B05D 3/00

(52) U.S. Cl. 428/446; 427/419.2; 427/419.1; 427/352

(57) ABSTRACT

A coating process, a coating, and a coated component are disclosed. The coating process includes providing a MCrAlY substrate, applying a thermal barrier coating to the MCrAlY substrate, applying a flash layer to the thermal barrier coating, the flash layer including an inert ceramic, applying a reaction product deposition onto the thermal barrier coating, the reaction product deposition including reaction products selected from the group consisting of a magnesium oxide compound, a magnesium orthovanadate compound, a magnesium vanadate compound, a magnesium pyrovanadate compound, a magnesium sulfate compound, and combinations thereof. The reaction products are by-products of a doped fuel.

### FIELD OF THE INVENTION

The present invention is directed to manufactured components and processes of manufacturing components. More specifically, the present invention is directed to coating processes, coatings, and coating components.

### BACKGROUND OF THE INVENTION

Modern high-efficiency combustion turbines have firing temperatures that exceed about 2000° F. (1093° C.), and firing temperatures continue to increase as demand for more efficient engines continues. Many components that form the “hot gas path” combustor and turbine sections are directly exposed to aggressive hot combustion gases, for example, the combustor liner, the transition duct between the combustion and turbine sections, and the turbine stationary vanes and rotating blades and surrounding ring segments. In addition to thermal stresses, these and other components are also exposed to mechanical stresses and loads that further wear on the components.

Many of the cobalt-based and nickel-based superalloy materials traditionally used to fabricate the majority of combustion turbine components used in the hot gas path section of the combustion turbine engine are insulated from the hot gas flow by coating the components with a thermal barrier coating in order to survive long-term operation in this aggressive high-temperature combustion environment.

Thermal barrier coating systems often consist of four layers: the metal substrate, metallic bond coat, thermally grown oxide, and ceramic topcoat. The ceramic topcoat is typically composed of yttria-stabilized zirconia (YSZ), which is desirable for having very low thermal conductivity while remaining stable at nominal operating temperatures typically seen in applications. Such ceramic topcoats can be expensive to apply and/or limited in application methodology.

YSZ is a well known material used to improve the performance of metals used in high temperature metals. The YSZ is applied, typically by a high temperature thermal spray coating process. The YSZ increases the operating temperature of the high temperature substrate metal. In addition, a bond coat is applied between the YSZ and the high temperature metal reduces the thermal mismatch between the YSZ and the high temperature metal, which improves the spallation resistance.

Gas turbine engines can be operated using a number of different fuels. These fuels are combusted in the combustor section of the engine at temperatures at or in excess of 2000° F. (1093° C.), and the gases of combustion are used to rotate the turbine section of the engine, located aft of the combustor section of the engine. Power is generated by the rotating turbine section as energy is extracted from the hot gases of combustion. It is generally economically beneficial to operate the gas turbine engines using the most inexpensive fuel available. One of the more abundant and inexpensive petroleum fuels is heavy fuel oil (HFO). One of the reasons that HFO is an economical fuel is that it is not heavily refined or it is a remaining portion of a refining process. Not being heavily refined, it contains a number of impurities. One of these impurities is vanadium, which forms vanadium oxide (V₂O₅) at the high temperatures of combustion. Even though MgO is added as a fuel additive and acts as an inhibitor for reaction of vanadium species that forms an inert magnesium vanadate compound on or near the outer surface of the thermal barrier coating, MgO does not completely prevent the attack of YSZ thermal barrier coatings, as vanadium oxide can penetrate microcracks and porosity in the thermal barrier coatings, providing access not only to the YSZ thermal barrier coating, but also the underlying bond coat. V₂O₅ is an acidic oxide that can leach yttria from YSZ in cracks and porosity that occur in such thermal barrier coatings. The mechanism of attack is provided by the following reaction:

ZrO₂(Y₂O₃)+V₂O₅→ZrO₂ (monoclinic)+2YVO₄

Thus, V₂O₅ maintains the ability to rapidly attack YSZ, causing it to deteriorate and be removed by the hot gas stream. The loss of the TBC exposes the substrate metal and any remaining bond coat to the hot gases of combustion at elevated temperatures. At these elevated temperatures, the substrate metal and the bond coat are subject to corrosion from the hot gases of combustion, which shorten their life. As a result, the components, such as combustors and turbine blades, must be replaced in shorter intervals, which also means additional maintenance time for the turbine during which time it is not producing power.

A coating process, a coating, and a coated component that do not suffer from the above drawbacks would be desirable in the art.

### BRIEF DESCRIPTION OF THE INVENTION

In an exemplary embodiment, a coating process includes providing a MCrAlY substrate, applying a thermal barrier coating to the MCrAlY substrate, applying a flash layer to the thermal barrier coating, and applying a reaction product deposition onto the thermal barrier coating. The flash layer includes an inert ceramic. The reaction product deposition includes reaction products selected from the group consisting of a magnesium oxide compound, a magnesium orthovanadate compound, a magnesium vanadate compound, a magnesium pyrovanadate compound, a magnesium sulfate compound, and combinations thereof. The reaction products are by-products of a doped fuel.

In another exemplary embodiment, a coating includes a thermal barrier coating, a flash layer including an inert ceramic, a reaction product deposition positioned on the thermal barrier coating, the reaction product deposition including reaction products selected from the group consisting of a magnesium oxide compound, a magnesium orthovanadate compound, a magnesium vanadate compound, a magnesium pyrovanadate compound, a magnesium sulfate compound, and combinations thereof. The reaction products are by-products of a doped fuel.

In another exemplary embodiment, a coated component includes a MCrAlY substrate, a thermal barrier coating, a flash layer including an inert ceramic, and a reaction product deposition positioned on the thermal barrier coating, the reaction product deposition including reaction products selected from the group consisting of a magnesium oxide compound, a magnesium orthovanadate compound, a magnesium vanadate compound, a magnesium pyrovanadate compound, a magnesium sulfate compound, and combinations thereof. The reaction products are by-products of a doped fuel.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary component coated by an exemplary coating process according to the disclosure.

FIG. 2 is an schematic view of an exemplary coating according to the disclosure.

FIG. 3 shows a schematic of an exemplary coating process according to the disclosure.

Wherever possible, the same reference numbers will be used throughout the drawings to represent the same parts.

### DETAILED DESCRIPTION OF THE INVENTION

Provided is an exemplary coating process, a coating, and a coated component. Embodiments of the present disclosure permit less expensive materials to be used along hot gas paths, permit use of materials that are more readily available, permit protection of substrates from high temperatures, permit application of various layers of a coating in situ, permit removal and/or re-application of coating, permit additional control of coatings thicknesses, permit combustors and/or other components to remain in operation more often, and combinations thereof.

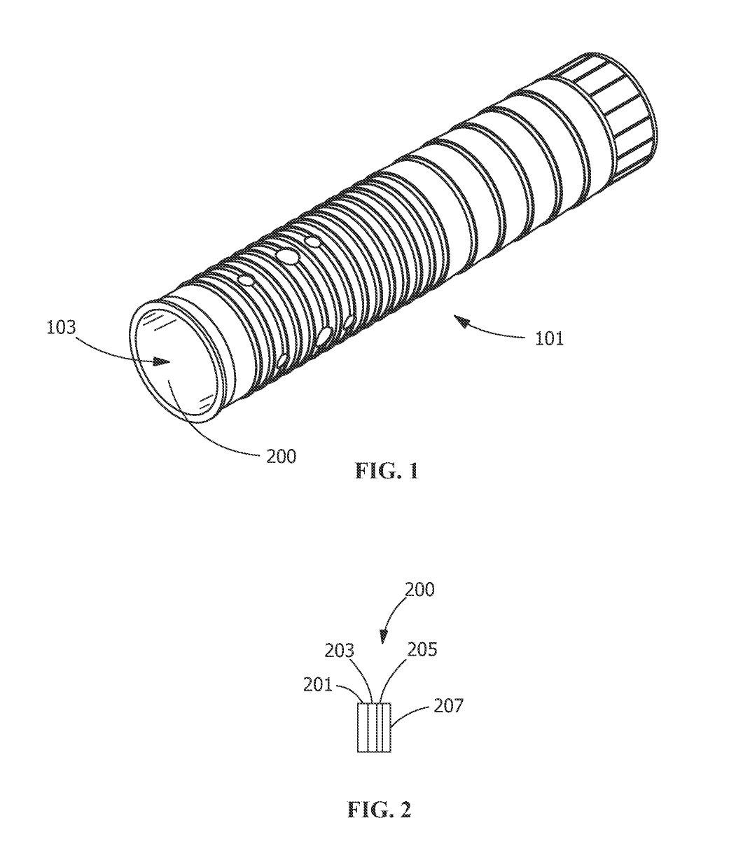

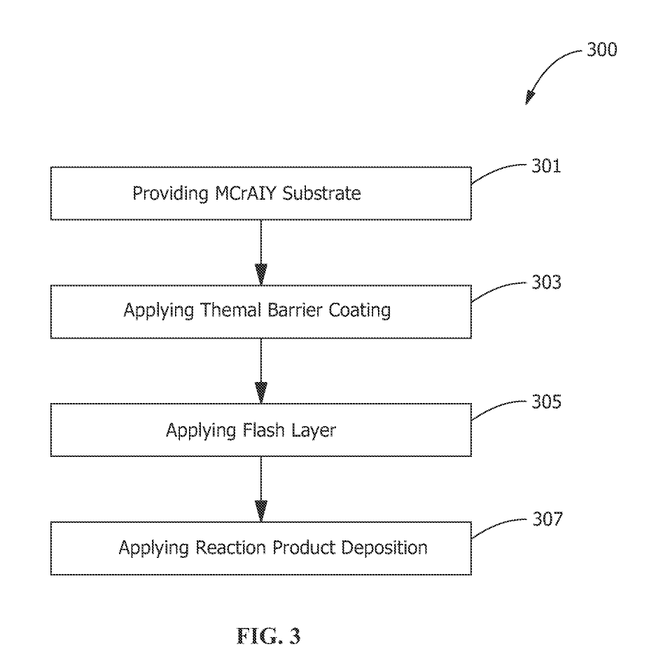

FIG. 1 shows a coated component 100 with a coating 200, as is further shown in FIG. 2, applied according to a coating process 300 shown in FIG. 3. The coated component 100 is any suitable component. For example, in one embodiment, the coated component 100 is a combustor. In a further embodiment, the coated component 100 is a liner for a combustor of a gas turbine. In other embodiments, the coated component 100 is or is a portion of a transition duct, a turbine stationary vane, a rotating blade, a ring segment, or a combination thereof.

Referring to FIG. 2, in one embodiment, the coating 200 includes a MCrAlY substrate 201, a thermal barrier coating 203, a flash layer 205, and a reaction product deposition 207. The coating 200 is positioned on any suitable portion of the coated component 100. As shown in FIG. 1, in one embodiment, the coating 200 is on an interior portion 101 of the component 100, such as along a hot gas path. In other embodiments, the coating 200 is on portions of the component 100 that are not interior portions or are not within a hot gas path.

The MCrAlY substrate 201 is a portion or all of the material forming the component 100. As used herein, the term “MCrAlY” refers to a composition having chromium, aluminum, yttrium, and M, where M is an element selected from the group consisting of nickel, iron, cobalt, and combinations thereof. The MCrAlY substrate includes MCrAlY within or consists of MCrAlY. In one embodiment, the MCrAlY substrate 201 includes, by weight, about 32% cobalt, about 22% nickel, about 10% chromium, about 0.3 aluminum, and yttrium. In a further embodiment, the MCrAlY substrate 201 includes, by weight, about 22% nickel, about 6% chromium, about 0.3 aluminum, and yttrium.

The thermal barrier coating 203 protects the MCrAlY substrate 201 from high temperatures, such as in a hot gas path of the component 100. As used herein, the term “thermal barrier coating” includes a metal or alloy selected from the group consisting of a platinum metal, an iridium metal, an iridium-hafnium metal, an iridium-platinum metal, a platinum-rhenium metal, a platinum-based alloy, an iridium-based alloy, an iridium-hafnium-based alloy, an iridium-platinum-based alloy, a platinum-rhenium-based alloy, and combinations thereof. In one embodiment, the thermal barrier coating 203 includes magnesium oxide and/or yttria-stabilized zirconia. In one embodiment, the thermal barrier coating 203 has a thickness of about 2 mils, about 4 mils, about 6 mils, about 10 mils, about 15 mils, between about 2 mils and about 4 mils, between about 4 mils and about 6 mils, between about 6 mils and about 10 mils, between about 10 mils and about 15 mils, or any suitable combination, sub-combination, range, or sub-range within.

The flash layer 205 provides corrosion resistance for the coating 200 of the component 100. The flash layer 205 includes an inert ceramic. In one embodiment, the flash layer 205 is resistant to vanadium, sulfur oxides, and/or other components of heavy fuel capable of causing corrosion. In one embodiment, the inert ceramic is selected from the group consisting of alumina (for example, at 13%, by weight), titania, magnesium zirconate, and combinations thereof. In one embodiment, the flash layer 205 has a thickness of about 1 mil, about 2 mils, about 3 mils, about 4 mils, about 5 mils, between about 1 mil and about 2 mils, between about 1 mil and about 3 mils, between about 1 mil and about 5 mils, between about 2 mils and about 3 mils, between about 3 mils and about 4 mils, or any suitable combination, sub-combination, range, or sub-range within. The flash layer 205 is resistant to vanadium, sulfur oxides, and/or other components of heavy fuel capable of causing corrosion.

The reaction product deposition 207 includes the reaction products that are by-products of a doped fuel. The doped fuel includes a heavy fuel having vanadium and sulfur oxides and magnesium-oxide formed by reaction of the heavy fuel. In one embodiment, the doped fuel includes magnesium oxide at a concentration, by weight, of greater than about 75%, greater than about 80%, greater than about 85%, about 75%, about 80%, about 85%, about 90%, between about 75% and about 90%, between about 80% and about 90%, between about 85% and about 90%, or any suitable combination, sub-combination, range, or sub-range within. In one embodiment, the fuel contains vanadium at a concentration of greater than 0.5 parts per million.

The reaction product deposition 207 includes reaction products selected from the group consisting of a magnesium oxide compound, a magnesium orthovanadate compound, a magnesium vanadate compound, a magnesium pyrovanadate compound, a magnesium sulfate compound, and combinations thereof. For example, in one embodiment, a portion or all of the reaction products are formed with one or more of the following reactions:

V₂O₅+3MgO+Heavy Fuel→Mg₂V₂O₇+MgSO₄ (Eq. 1)

Mg₃(VO₄)₂+SO₃+Heavy Fuel→Mg₂V₂O₇+MgSO₄ (Eq. 2)

MgSO₄+Heavy Fuel→MgO+SO₃ (Eq. 3)

Referring to FIG. 3, in one embodiment, the coating process 300 includes providing the MCrAlY substrate 201 (step 301), applying the thermal barrier coating 203 to at least a portion of the MCrAlY substrate 201 (step 303), applying the flash layer 205 to at least a portion of the thermal barrier coating 203 (step 305), and applying the reaction product deposition 207 onto at least a portion of the thermal barrier coating 203 (step 307). In further embodiments, the coating process 300 includes applying the thermal barrier coating 203 to all of the MCrAlY substrate 201 (step 303), applying the flash layer 205 to all of the thermal barrier coating 203 (step 305), applying the reaction product deposition 207 onto all of the thermal barrier coating 203 (step 307), or a combination thereof.

The reaction products are deposited by combusting the doped fuel at a temperature greater than about 2000° F. in a primary combustion zone. In one embodiment, the reaction product deposition 207 includes an amount of magnesium, such as, at least about 200 parts per million magnesium, at least about 800 parts per million magnesium, 200 parts per million, 800 parts per million, 1000 parts per million magnesium, 1200 parts per million magnesium, 1400 parts per million magnesium, 1500 parts per million magnesium, 1600 parts per million magnesium, or any suitable combination, sub-combination, range, or sub-range within. In one embodiment, the high amount of magnesium is applied (step 307) for a period, such as about thirty minutes, about forty-five minutes, about one hour, about seventy-five minutes, about ninety minutes, between about forty-five minutes and about ninety minutes, between about forty-five minutes and about seventy-five minutes, or any suitable combination, sub-combination, range, or sub-range within.

The coating process 300 includes any suitable additional steps. For example, in one embodiment, the process 300 further includes combusting a lower-doped fuel, in comparison to the doped fuel used for applying the reaction product deposition 207, thereby applying and/or replenishing the reaction products in the reaction product deposition, the flash layer 205, or a combination thereof.

In one embodiment, the lower-doped fuel includes an amount of magnesium, such as, about 200 parts per million magnesium, about 400 parts per million magnesium, about 600 parts per million magnesium, about 650 parts per million magnesium, about 550 parts per million magnesium, less than about 700 parts per million magnesium, between about 500 parts per million magnesium and about 700 parts per million, or any suitable combination, sub-combination, range, or sub-range within. In one embodiment, the amount of magnesium in the lower-doped fuel corresponds to an amount of vanadium, for example, at a ratio of about three parts magnesium to one part vanadium. In one embodiment, the lower-doped fuel is applied for a period, such as about thirty minutes, about forty-five minutes, about one hour, about seventy-five minutes, about ninety minutes, between about forty-five minutes and about ninety minutes, between about forty-five minutes and about seventy-five minutes, or any suitable combination, sub-combination, range, or sub-range within.

In one embodiment, the coating process 300 includes removing at least a portion of the reaction product deposition 207, by a dry cleaning process, by a wet cleaning process, or a combination thereof. The dry cleaning process slightly abrades the thermal barrier coating 203, the flash layer 205, and/or the reaction product deposition 207. The dry cleaning process does not impact the MCrAlY substrate 201. In one embodiment, the dry cleaning process is performed by projecting particles against the coating 200. For example, in one embodiment, particles, such as nut shell fragments, are projected against the coating 200. In a further embodiment, with the coating 200 being in a combustor, the particles are applied during operation of the combustor. The wet cleaning process includes injecting and/or applying water and/or a cleaning solution, thereby removing portions of the flash layer 205 and/or the reaction product deposition 207, without impacting the MCrAlY substrate 201.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A coating process, comprising:
providing a MCrAlY substrate;
applying a thermal barrier coating to the MCrAlY substrate;
applying a flash layer to the thermal barrier coating, the flash layer including an inert ceramic; and
applying a reaction product deposition onto the thermal barrier coating, the reaction product deposition including reaction products selected from the group consisting of a magnesium oxide compound, a magnesium orthovanadate compound, a magnesium vanadate compound, a magnesium pyrovanadate compound, a magnesium sulfate compound, and combinations thereof;
wherein the reaction products are by-products of a doped fuel.

2. The coating process of claim 1, wherein the MCrAlY substrate is a portion of a combustor.

3. The coating process of claim 1, wherein the applying of the reaction product deposition is performed by combusting the doped fuel at a temperature greater than about 1650° F.

4. The coating process of claim 1, wherein the applying of the reaction product deposition is performed by combusting the doped fuel at a temperature of about 2000° F.

5. The coating process of claim 1, wherein the reaction product deposition includes at least about 1400 parts per million magnesium per a one-hour period.

6. The coating process of claim 1, further comprising combusting a lower-doped fuel.

7. The coating process of claim 6, wherein the lower-doped fuel deposits the reaction products onto the flash layer, the reaction product deposition, or a combination thereof.

8. The coating process of claim 1, wherein the doped fuel includes magnesium oxide at a concentration, by weight, of greater than about 75%.

9. The coating process of claim 1, wherein the doped fuel includes magnesium oxide at a concentration, by weight, of about 90%.

10. The coating process of claim 1, wherein the inert ceramic is selected from the group consisting of alumina, titania, magnesium zirconate, and combinations thereof.

11. The coating process of claim 1, further comprising removing at least a portion of the reaction product deposition.

12. The coating process of claim 11, wherein the removing is by a dry cleaning process.

13. The coating process of claim 11, wherein the removing is by a wet cleaning process.

14. A coating, comprising:
a thermal barrier coating;
a flash layer including an inert ceramic; and
a reaction product deposition positioned on the thermal barrier coating, the reaction product deposition including reaction products selected from the group consisting of a magnesium oxide compound, a magnesium orthovanadate compound, a magnesium vanadate compound, a magnesium pyrovanadate compound, a magnesium sulfate compound, and combinations thereof;
wherein the reaction products are by-products of a doped fuel.

15. The coating of claim 14, wherein the doped fuel includes magnesium oxide at a concentration, by weight, of greater than about 75%.

16. A coated component, comprising:
a MCrAlY substrate;
a thermal barrier coating;
a flash layer including an inert ceramic; and
a reaction product deposition positioned on the thermal barrier coating, the reaction product deposition including reaction products selected from the group consisting of a magnesium oxide compound, a magnesium orthovanadate compound, a magnesium vanadate compound, a magnesium pyrovanadate compound, a magnesium sulfate compound, and combinations thereof;
wherein the reaction products are by-products of a doped fuel.

17. The coated component of claim 16, wherein the doped fuel includes magnesium oxide at a concentration, by weight, of greater than about 75%.

18. The coated component of claim 16, wherein the doped fuel includes magnesium oxide at a concentration, by weight, of about 90%.

19. The coated component of claim 16, wherein the MCrAlY substrate is a portion of a combustor.

20. The coated component of claim 16, wherein the MCrAlY substrate is a liner for a combustor of a gas turbine.
